(19) United States
(12) Patent Application Publication
(10) Pub. No.: US 2012/0093013 A1
(43) Pub. Date: Apr. 19, 2012

(54) Calculation Method and Device of Intra-Turbo Code Interleaver

(75) Inventor: Shaoning Xiao, Shenzhen (CN)

(73) Assignee: ZTE CORPORATION, Shenzhen, Guangdong (CN)

(21) Appl. No.: 13/259,026

(22) PCT Filed: Apr. 23, 2010
(86) PCT No.: PCT/CN10/72164

§ 371 Date: Dec. 23, 2011

(30) Foreign Application Priority Data
Jun. 24, 2009 (CN) 200910087635.9

(51) Int. Cl. H04W 24/00

(52) U.S. Cl. 370/252

(57) ABSTRACT

A calculation method of a turbo code internal interleaver is disclosed by the present invention, and comprises: dividing a sequence with a length of Kⱼ, which is input into a turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ; obtaining output indices each of which corresponds to each input index in a first window; calculating successively output indices each of which corresponds to each input index in a rest window according to the output indices each of which corresponds to each input index in the first window. A calculation device of a turbo code internal interleaver is also disclosed by the present invention. With the present invention, the computational complexity of the turbo code internal interleaver can be reduced, so as to reduce the time delay of a specific calculation and save memory resources.

### TECHNICAL FIELD

The present invention relates to the Long Term Evolution (LTE) technology in the 3rd Generation Partnership Project (3GPP), particularly to a calculation method and device of turbo code internal interleaver in the LTE.

### BACKGROUND

The internal interleaver in a turbo code encoder or turbo code decoder uses

Formula (1) to calculate an output index according to an input index:

Π(i)=(f₁·i+f₂·i₂)mod K (1)

where i is an input index and set to 0, 1, 2, . . . , K−1;
Π(i) is an output index;
f₁ and f₂ are parameters dependent on K;
K is a length of an input sequence.

When Formula (1) is used in a turbo code encoder, the input sequence is a bit sequence; when it is used in a turbo code decoder, the input sequence is a soft bit sequence which refers to a non-binary sequence.

Further, the concrete values of f₁, f₂ and K may be obtained from the parameter table of a turbo code internal interleaver in 3GPP TS 36.212 Evolved Universal Terrestrial Radio Access (E-UTRA); Multiplexing and channel coding (Release 8) v8.5.0 (2008-12).

When prior art directly uses Formula (1) to calculate output index Π(i), excessive modular arithmetic is involved, making the calculation very complex and thereby consuming excessive memory resources and resulting in a long time delay in implementation of the encoding process of a turbo code encoder or implementation of the decoding process of a turbo code decoder.

### SUMMARY

For this reason, the main object of the present invention is to provide a calculation method of a turbo code internal interleaver, which can reduce computational complexity, so as to save memory resources and reduce time delay.

To achieve the foregoing object, the technical solution of the present invention is realized in the following way.

A calculation method of a turbo code internal interleaver comprises:

dividing a sequence with a length of Kⱼ, which is input into a turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ;

obtaining output indices each of which corresponds to each input index in a first window;

calculating successively output indices each of which corresponds to each input index in a rest window according to the output indices each of which corresponds to each input index in the first window.

A formula used for calculating the output indices each of which corresponds to each input index in the rest window may be:

Π(i+k·Δⱼ)=Π(i)+[k·(f₁Δⱼ+f₂Δⱼ²)](mod Kⱼ)

where i is an input index in the first window and set to 0, 1, 2, . . . , Δⱼ−1;
a value of k is set to 1, 2, . . . ,

$$\frac{{K}_{j}}{{Δ}_{j}} - 1 ;$$

Δⱼ is window length;
f₁ and f₂ are parameters dependent on Kⱼ;
Kⱼ is the length of the sequence.

A formula used for calculating the output indices each of which corresponds to each input index in the rest window may be:

Π(i+Δⱼ)=Π(i)+(f₁·Δⱼ+f₂·Δⱼ²)(mod Kⱼ)

where i is an input index in a previous window and set to 0, 1, 2, . . . , Δⱼ−1;
Δⱼ is window length;
f₁ and f₂ are parameters dependent on Kⱼ;
Kⱼ is the length of the sequence.

The plurality of windows may refer to two or more windows.

The step of obtaining output indices each of which corresponds to each input index in the first window may refer to: reading from a memory or obtaining through calculation.

The step of obtaining output indices each of which corresponds to each input index in the first window through calculation may be calculating with a following formula:

Π(i)=(f₁·i+f₂·i²)mod Kⱼ

where i is an input index and set to 0, 1, 2, . . . , Kⱼ−1.

The sequence may be a bit sequence or a soft bit sequence.

A calculation device of a turbo code internal interleaver comprises:

a window setting module, for dividing a sequence with a length of Kⱼ, which is input into a turbo code internal interleaver, into a plurality of windows each with a window is length of Δⱼ, the window length Δⱼ satisfying 2f₂Δⱼ(mod Kⱼ)=0, and Kⱼ being divided exactly by Δⱼ, wherein f₂ is a parameter dependent on Kⱼ;

a first output index obtaining module, for obtaining output indices each of which corresponds to each input index in a first window; and

a second output index obtaining module, for calculating successively output indices each of which corresponds to each input index in a rest window according to the output indices each of which corresponds to each input index in the first window.

The first output index obtaining module may be specifically used for reading from a memory or obtaining through calculation the output indices each of which corresponds to each input index in the first window.

The plurality of windows may refer to two or more windows; and/or

the sequence may be a bit sequence or a soft bit sequence.

From the foregoing technical solution, it may be known that by dividing a sequence with a length of Kⱼ into a plurality of windows each with a window length of Δⱼ, and making the window length Δⱼ satisfy 2f₂Δⱼ(mod Kⱼ)=0 and Kⱼ divided exactly by Δⱼ, starting from the second window, the present invention can obtain through calculation the output indices each of which corresponds to each input index in each window according to the output indices each of which corresponds to each input index in the first window. The modular arithmetic involved in this method is very simple, therefore the method can significantly reduce the computational complexity of the turbo code internal interleaver, thereby saving the memory resources used for this computation. In other words, it may reduce the memory area used for this computation, thereby reducing cost. Further, the output indices obtained through calculation are used for a turbo code encoder or turbo code decoder. As the computational complexity of the turbo code internal interleaver is reduced, the time delay in the implementation of the entire encoding process of a turbo code encoder or in the implementation of the entire decoding process of a turbo code decoder is reduced; thus, the present invention can save the cost and time delay of the whole system.

### BRIEF DESCRIPTION OF THE DRAWINGS

FIG. 1 is a schematic diagram showing a flow of a calculation method of a turbo code internal interleaver according to the present invention;

FIG. 2 is a schematic diagram showing a structure of a calculation device of a turbo code internal interleaver according to the present invention.

### DETAILED DESCRIPTION

Before detailed description of a calculation method of a turbo code internal interleaver according to the present invention, the principle of this calculation method is introduced.

Firstly, a bit sequence or soft bit sequence with a length of Kⱼ, which is input into the turbo code internal interleaver, is divided into a plurality of segments which have a same length. Each segment is called a window. It is supposed that the length of each window is Δⱼ, an input index of an element a in window n is i, and an output index after i is interleaved with Formula (1) is Π(i); in window n+1, the input index of element b with a distance of Δⱼ, from element a is i+Δⱼ, and the output index after i+Δⱼ is interleaved with Formula (1) is Π(i+Δⱼ)=[f₁(i+Δⱼ)+f₂(i+Δⱼ)²](mod Kⱼ).

Successively, the following equation may be obtained:

$$\begin{matrix}Π ( i + {Δ}_{j} ) - Π ( i ) = [ {f}_{1} \cdot ( i + {Δ}_{j} ) + {f}_{2} \cdot {( i + {Δ}_{j} )}^{2} - {f}_{1} \cdot i - {f}_{2} \cdot {i}^{2} ] ( {mod K}_{j} ) \\ = [ {f}_{1} \cdot {Δ}_{j} + {f}_{2} \cdot {Δ}_{j}^{2} + 2 {f}_{2} {Δ}_{j} i ] ( {mod K}_{j} )\end{matrix}$$

From the foregoing equation, it may be known that if 2f₂Δⱼ(mod Kⱼ)=0, then 2f₂Δⱼi(mod Kⱼ)=0, and Formula (2) may be obtained:

Π(i+Δⱼ)=Π(i)+[f₁·Δⱼ+f₂·Δ²](mod Kⱼ) (2)
i.e., Π(i+Δⱼ)=Π(i)+Constant independent of i (mod Kⱼ).

Therefore, if window length Δⱼ can satisfy 2f₂Δⱼ(mod Kⱼ)=0, then an output index of an element in a subsequent window may be easily calculated based on the output index of the element in the first window.

In fact, according to the parameter table of the turbo code internal interleaver, for every Kⱼ, an appropriate Δⱼ can be obtained to make 2f₂Δⱼ (mod Kⱼ)=0 and Kⱼ divided exactly by Δⱼ. According to the parameter table of the turbo code internal interleaver, the range of j is 1, 2, 3, . . . , 188.

For example, Kⱼ=40, f₁=3, f₂=10, to make 2×10×Δⱼ mod 40=0 and 40 divided exactly by Δⱼ, Δⱼ may be set to 20. Here, the value of Δⱼ is not exclusive as long as 2f₂Δⱼ (mod Kⱼ)=0 is satisfied and Kⱼ is divided exactly by Δⱼ. For example, Δⱼ may be 2 or 4.

Therefore, from the foregoing example, it may be known that for different Kⱼ, as long as 2f₂Δⱼ(mod Kⱼ)=0 is satisfied and Kⱼ is divided exactly by Δⱼ, Δⱼ may be set to different values.

Here, those skilled in the art may know why Δⱼ needs to satisfy the condition that Kⱼ is divided exactly by Δⱼ in addition to satisfying the condition of 2f₂Δⱼ(mod Kⱼ)=0. This is because all windows should have a same length and the number of windows should be an integer.

From Formula (2), Formula (3) may be deduced:

Π(i+k·Δⱼ)=Π(i)+[k·(f₁·Δⱼ+f₂·Δⱼ²)](mod Kⱼ) (3)

where i is an input index in the first window and set to 0, 1, 2, . . . , Δⱼ−1;

the value of k is set to 1, 2, . . . ,

$$\frac{{K}_{j}}{{Δ}_{j}} - 1.$$

When k=1, it means the output indices each of which corresponds to each input index in the second window is calculated based on the output indices Π(i) each of which corresponds to each input index i in the first window. When k is another value, the rest may be deduced by analogy.

Below the technical solution of the present invention is described in details.

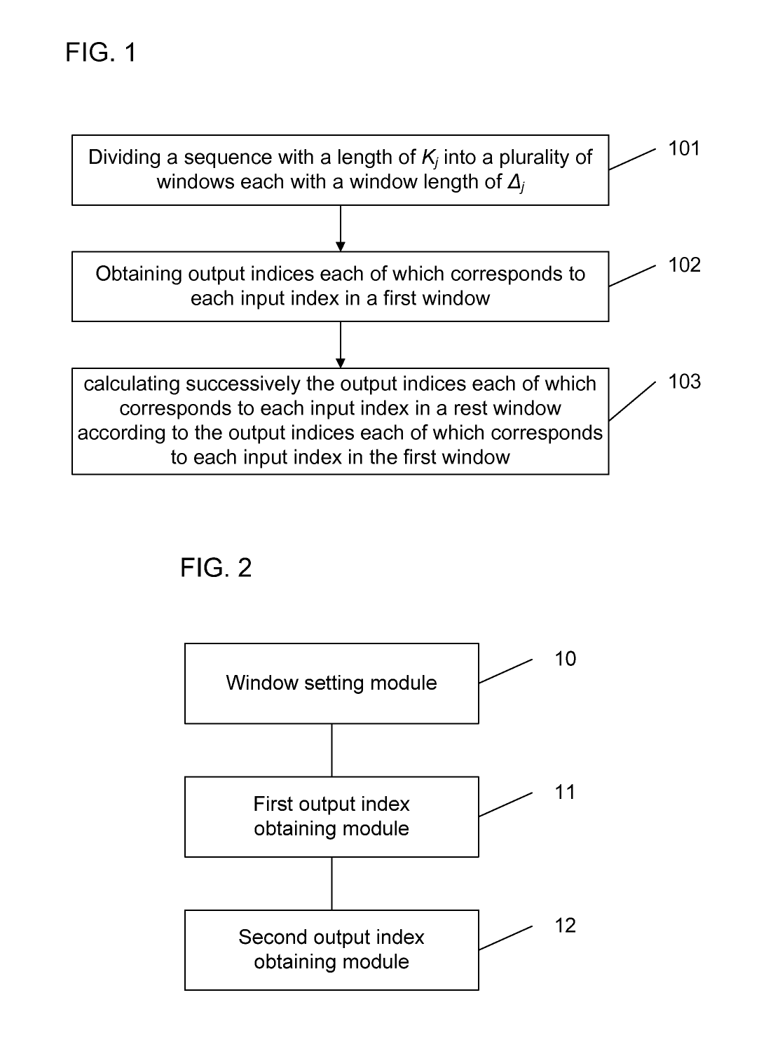

As shown in FIG. 1, a calculation method of a turbo code internal interleaver according to the present invention comprises the following steps.

S101, dividing a sequence with a length of Kⱼ, which is input into the turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ.

The sequence is a bit sequence or soft bit sequence; the soft bit sequence refers to a non-binary sequence.

The plurality of windows refers to two or more windows.

S102, obtaining output indices each of which corresponds to each input index in a first window.

When a memory stores pre-calculated output indices each of which corresponds to each input index in the first window, then the output indices each of which corresponds to each input index in the first window may be directly read from the memory, or obtained through calculation with Formula (1).

S103, calculating successively the output indices each of which corresponds to each input index in a rest window according to the output indices each of which corresponds to each input index in the first window.

The so-called “successively” refers to: calculating the output indices each of which corresponds to each input index in a window at first, and then calculating the output indices each of which corresponds to each input index in a next window.

The actual calculation formula may be Formula (3) as described above:

Π(i+k·Δⱼ)=Π(i)+[k·(f₁·Δⱼ+f₂·Δⱼ²)](mod Kⱼ) (3)

where i is an input index in the first window and set to 0, 1, 2, . . . , Δⱼ−1;
the value of k is set to 1, 2, . . . ,

$$\frac{{K}_{j}}{{Δ}_{j}} - 1 ;$$

Δⱼ is window length;
f₁ and f₂ are parameters dependent on Kⱼ;
Kⱼ is the length of the sequence.

Alternatively, Formula (4) may be adopted for the calculation, i.e. calculating the output indices each of which corresponds to each input index in a next window according to the output indices each of which corresponds to each input index in a previous window.

Π(i+Δⱼ)=Π(i)+(f₁·Δⱼ+f₂·Δⱼ²)(mod Kⱼ) (4)

where i is an input index in the previous window and set to 0, 1, 2, . . . , Δⱼ−1;
Δⱼ is window length;
f₁ and f₂ are parameters dependent on Kⱼ;
Kⱼ is the length of the sequence.

In the following parameter matrix of the turbo code internal interleaver, the first column is Kⱼ, the second column is f₁, the third column is f₂, and the fourth column is Δⱼ:

$$\begin{matrix}interleave\_matrix = … & \\ \begin{matrix}[ 40 & 3 & 10 & 20 ; \\ 48 & 7 & 12 & 16 ; \\ 56 & 19 & 42 & 28 ; \\ 64 & 7 & 16 & 64 ; \\ 72 & 7 & 18 & 36 ; \\ 80 & 11 & 20 & 40 ; \\ 88 & 5 & 22 & 22 ; \\ 96 & 11 & 24 & 32 ; \\ 104 & 7 & 26 & 26 ; \\ 112 & 41 & 84 & 16 ; \\ 120 & 103 & 90 & 8 ; \\ 128 & 15 & 32 & 32 ; \\ 136 & 9 & 34 & 8 ; \\ 144 & 17 & 108 & 16 ; \\ 152 & 9 & 38 & 8 ; \\ 160 & 21 & 120 & 32 ; \\ 168 & 101 & 84 & 24 ; \\ 176 & 21 & 44 & 16 ; \\ 184 & 57 & 46 & 8 ; \\ 192 & 23 & 48 & 32 ; \\ 200 & 13 & 50 & 8 ; \\ 208 & 27 & 52 & 16 ; \\ 216 & 11 & 36 & 27 ; \\ 224 & 27 & 56 & 32 ; \\ 232 & 85 & 58 & 8 ; \\ 240 & 29 & 60 & 16 ; \\ 248 & 33 & 62 & 8 ; \\ 256 & 15 & 32 & 32 ; \\ 264 & 17 & 198 & 8 ; \\ 272 & 33 & 68 & 8 ; \\ 280 & 103 & 210 & 8 ; \\ 288 & 19 & 36 & 32 ; \\ 296 & 19 & 74 & 296 ;\end{matrix} & \\ \begin{matrix}304 & 37 & 76 & 16 ; \\ 312 & 19 & 78 & 8 ; \\ 320 & 21 & 120 & 16 ; \\ 328 & 21 & 82 & 8 ; \\ 336 & 115 & 84 & 16 ; \\ 334 & 193 & 86 & 8 ; \\ 352 & 21 & 44 & 32 ; \\ 360 & 133 & 90 & 8 ; \\ 368 & 81 & 46 & 16 ; \\ 376 & 45 & 94 & 8 ; \\ 384 & 23 & 48 & 8 ; \\ 392 & 243 & 98 & 8 ; \\ 400 & 151 & 40 & 10 ; \\ 408 & 155 & 102 & 8 ; \\ 416 & 25 & 52 & 8 ; \\ 424 & 51 & 106 & 8 ; \\ 432 & 47 & 72 & 12 ; \\ 440 & 91 & 110 & 8 ; \\ 448 & 29 & 168 & 64 ; \\ 456 & 29 & 114 & 8 ; \\ 464 & 247 & 58 & 16 ; \\ 472 & 29 & 118 & 8 ; \\ 480 & 89 & 180 & 32 ; \\ 488 & 91 & 122 & 8 ; \\ 496 & 157 & 62 & 16 ; \\ 504 & 55 & 84 & 24 ; \\ 512 & 31 & 64 & 32 ;\end{matrix} & \\ \begin{matrix}528 & 17 & 66 & 16 ; \\ 544 & 35 & 68 & 32 ; \\ 560 & 227 & 420 & 16 ; \\ 576 & 65 & 96 & 12 ; \\ 592 & 19 & 74 & 16 ; \\ 608 & 37 & 76 & 32 ; \\ 624 & 41 & 234 & 16 ; \\ 640 & 39 & 80 & 16 ; \\ 656 & 185 & 82 & 16 ; \\ 672 & 43 & 252 & 32 ; \\ 688 & 21 & 86 & 16 ; \\ 704 & 155 & 44 & 64 ; \\ 720 & 79 & 120 & 48 ; \\ 736 & 139 & 92 & 32 ; \\ 752 & 23 & 94 & 16 ; \\ 768 & 217 & 48 & 64 ; \\ 784 & 25 & 98 & 16 ; \\ 800 & 17 & 80 & 40 ; \\ 816 & 127 & 102 & 16 ; \\ 832 & 25 & 52 & 64 ; \\ 848 & 239 & 106 & 16 ; \\ 864 & 17 & 48 & 36 ; \\ 880 & 137 & 110 & 16 ; \\ 896 & 215 & 112 & 64 ; \\ 912 & 29 & 114 & 16 ; \\ 928 & 15 & 58 & 32 ; \\ 944 & 147 & 118 & 16 ;\end{matrix} & \\ \begin{matrix}960 & 29 & 60 & 64 ; \\ 976 & 59 & 122 & 16 ; \\ 992 & 65 & 124 & 32 ; \\ 1008 & 55 & 84 & 48 ; \\ 1024 & 31 & 64 & 64 ; \\ 1056 & 17 & 66 & 32 ; \\ 1088 & 171 & 204 & 64 ; \\ 1120 & 67 & 140 & 32 ; \\ 1152 & 35 & 72 & 32 ; \\ 1184 & 19 & 74 & 32 ; \\ 1216 & 39 & 76 & 64 ; \\ 1248 & 19 & 78 & 32 ; \\ 1280 & 199 & 240 & 32 ; \\ 1312 & 21 & 82 & 32 ; \\ 1344 & 211 & 252 & 64 ; \\ 1376 & 21 & 86 & 32 ; \\ 1408 & 43 & 88 & 64 ; \\ 1440 & 149 & 60 & 96 ; \\ 1472 & 45 & 92 & 64 ; \\ 1504 & 49 & 846 & 32 ; \\ 1536 & 71 & 48 & 64 ; \\ 1568 & 13 & 28 & 28 ; \\ 1600 & 17 & 80 & 20 ; \\ 1632 & 25 & 102 & 32 ; \\ 1664 & 183 & 104 & 64 ; \\ 1696 & 55 & 954 & 32 ; \\ 1728 & 127 & 96 & 36 ;\end{matrix} & \\ \begin{matrix}1760 & 27 & 110 & 32 ; \\ 1792 & 29 & 112 & 64 ; \\ 1824 & 29 & 114 & 32 ; \\ 1856 & 57 & 116 & 64 ; \\ 1888 & 45 & 354 & 32 ; \\ 1920 & 31 & 120 & 64 ; \\ 1952 & 59 & 610 & 32 ; \\ 1984 & 185 & 124 & 64 ; \\ 2016 & 113 & 420 & 48 ; \\ 2048 & 31 & 64 & 64 ; \\ 2112 & 17 & 66 & 64 ; \\ 2176 & 171 & 136 & 64 ; \\ 2240 & 209 & 420 & 64 ; \\ 2304 & 253 & 216 & 64 ; \\ 2368 & 367 & 444 & 64 ; \\ 2432 & 265 & 456 & 64 ; \\ 2496 & 181 & 468 & 64 ; \\ 2560 & 39 & 80 & 64 ; \\ 2624 & 27 & 164 & 64 ; \\ 2688 & 127 & 504 & 64 ; \\ 2752 & 143 & 172 & 64 ; \\ 2816 & 43 & 88 & 64 ; \\ 2880 & 29 & 300 & 24 ; \\ 2944 & 45 & 92 & 64 ; \\ 3008 & 157 & 188 & 64 ; \\ 3072 & 47 & 96 & 64 ; \\ 3136 & 13 & 28 & 56 ;\end{matrix} & \\ \begin{matrix}3200 & 111 & 240 & 60 ; \\ 3264 & 443 & 204 & 64 ; \\ 3328 & 51 & 104 & 64 ; \\ 3392 & 51 & 212 & 64 ; \\ 3456 & 451 & 192 & 72 ; \\ 3520 & 257 & 220 & 64 ; \\ 3584 & 57 & 336 & 64 ; \\ 3648 & 313 & 228 & 64 ; \\ 3712 & 271 & 232 & 64 ; \\ 3776 & 179 & 236 & 64 ; \\ 3840 & 331 & 120 & 64 ; \\ 3904 & 363 & 244 & 64 ; \\ 3968 & 375 & 248 & 64 ; \\ 4032 & 127 & 168 & 36 ; \\ 4096 & 31 & 64 & 64 ; \\ 4160 & 33 & 130 & 64 ; \\ 4224 & 43 & 264 & 64 ; \\ 4288 & 33 & 134 & 64 ; \\ 4352 & 477 & 408 & 64 ; \\ 4416 & 35 & 138 & 64 ; \\ 4480 & 233 & 280 & 64 ; \\ 4544 & 357 & 142 & 64 ; \\ 4608 & 377 & 480 & 72 ; \\ 4672 & 37 & 146 & 64 ; \\ 4736 & 71 & 444 & 64 ; \\ 4800 & 71 & 120 & 60 ; \\ 4864 & 37 & 152 & 64 ;\end{matrix} & \\ \begin{matrix}4928 & 39 & 462 & 64 ; \\ 4992 & 127 & 234 & 64 ; \\ 5056 & 39 & 158 & 64 ; \\ 5120 & 39 & 80 & 64 ; \\ 5184 & 31 & 96 & 54 ; \\ 5248 & 113 & 902 & 64 ; \\ 5312 & 41 & 166 & 64 ; \\ 5376 & 251 & 336 & 64 ; \\ 5440 & 43 & 170 & 64 ; \\ 5504 & 21 & 86 & 64 ; \\ 5568 & 43 & 174 & 64 ; \\ 5632 & 45 & 176 & 64 ; \\ 5696 & 45 & 178 & 64 ; \\ 5760 & 161 & 120 & 24 ; \\ 5824 & 89 & 182 & 64 ; \\ 5888 & 323 & 184 & 64 ; \\ 5952 & 47 & 186 & 64 ; \\ 6016 & 23 & 94 & 64 ; \\ 6080 & 47 & 190 & 64 ; \\ 6144 & 263 & 480 & 64 ] ;\end{matrix} & \end{matrix}$$

The above parameter matrix of the turbo code internal interleaver lists the reasonable values of Δⱼ in real application.

Below the technical solution of the present invention is further described in combination with an embodiment.

When the length Kⱼ of a bit sequence, which is input into the turbo code internal interleaver, is 6144, it may be known from the parameter table of the turbo code internal interleaver that f₁=263, f₂=480. According to the condition that window length Δⱼ needs to satisfy 2f₂Δⱼ (mod Kⱼ)=0 and Kⱼ is divided exactly by Δⱼ, window length is set to Δⱼ=64, then there will be 6144/64=96 windows.

64 is not the only value of window length Δⱼ, but is used here as an example only.

The output indices each of which corresponds to each input index in the first window are read from the memory or obtained through calculation with Formula (1).

The input index i in the first window is 0, 1, 2, . . . , 63.

Supposing k=1, the output indices each of which corresponds to each input index in the second window are calculated with Formula (3).

The formula used to calculate the output indices each of which corresponds to each input index in the second window is:

$$\begin{matrix}Π ( i + 64 ) = Π ( i ) + ( 263 \times 64 + 480 \times {64}^{2} ) ( mod 6144 ) \\ = Π ( i ) + 4544\end{matrix}$$

Next, the output indices each of which corresponds to each input index in the rest windows are successively calculated with Formula (3).

In this embodiment, except the first window, the general formula used for calculating the output indices each of which corresponds to each input index in the rest windows is:

$$\begin{matrix}Π ( i + k \cdot 64 ) = Π ( i ) + [ k \cdot ( 263 \times 64 + 480 \times {64}^{2} ) ] ( mod 6144 ) \\ = Π ( i ) + ( k \cdot 4544 ) ( mod 6144 )\end{matrix}$$

where k is set to 1, 2, 3, . . . , 95.

From the above analysis, it may be known that when the present invention calculates the output indices each of which corresponds to each input index in a window, the modular arithmetic involved is very simple, so compared with the prior art, the present invention significantly reduces the computational complexity of the turbo code internal interleaver.

To realize the foregoing method, the present invention provides a calculation device of the turbo code internal interleaver accordingly, as shown in FIG. 2. This calculation device comprises:

a window setting module 10, for dividing a sequence with a length of Kⱼ, which is input into the turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ;

a first output index obtaining module 11, for obtaining output indices each of which corresponds to each input index in a first window, and the output indices in the first window may be read from a memory or obtained through calculation; and

a second output index obtaining module 12, for calculating successively output indices each of which corresponds to each input index in a rest window according to the output indices each of which corresponds to each input index in the first window.

The first output index obtaining module 11 is specifically used for reading from the memory or obtaining through calculation the output indices each of which corresponds to each input index in the first window.

The plurality of windows refers to two or more windows.

The sequence is a bit sequence or a soft bit sequence.

The foregoing description is a preferred embodiment of the present invention and is not intended to limit the protection scope of the present invention.

What is claimed is:

1. A calculation method of a turbo code internal interleaver, comprising:
dividing a sequence with a length of Kⱼ, which is input into a turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ;
obtaining output indices each of which corresponds to each input index in a first window;
calculating successively output indices each of which corresponds to each input index in a rest window according to the output indices each of which corresponds to each input index in the first window.

2. The method according to claim 1, wherein a formula used for calculating the output indices each of which corresponds to each input index in the rest window is:
Π(i+k·Δⱼ)=Π(i)+[k·(f₁·Δⱼ+f₂·Δⱼ²)](mod Kⱼ)
where i is an input index in the first window and set to 0, 1, 2, . . . , Δⱼ−1;
a value of k is set to 1, 2, . . . ,
$$\frac{{K}_{j}}{{Δ}_{j}} - 1 ;$$
Δⱼ is window length;
f₁ and f₂ are parameters dependent on Kⱼ;
Kⱼ is the length of the sequence.

3. The method according to claim 1, wherein a formula used for calculating the output indices each of which corresponds to each input index in the rest window is:
Π(i+Δⱼ)=Π(i)+(f₁·Δⱼ+f₂·Δⱼ²)(mod Kⱼ)
where i is an input index in a previous window and set to 0, 1, 2, . . . , Δⱼ1;
Δⱼ is window length;
f₁ and f₂ are parameters dependent on Kⱼ;
Kⱼ is the length of the sequence.

4. The method according to claim 1, wherein the plurality of windows refers to two or more windows.

5. The method according to claim 1, wherein the step of obtaining output indices each of which corresponds to each input index in the first window, refers to: reading from a memory or obtaining through calculation.

6. The method according to claim 5, wherein the step of obtaining output indices each of which corresponds to each input index in the first window through calculation is calculating with a following formula:
Π(i)=(f₁·i+f₂·i₂)mod Kⱼ
where i is an input index and set to 0, 1, 2, . . . , Kⱼ−1.

7. The method according to claim 1, wherein the sequence is a bit sequence or a soft bit sequence.

8. A calculation device of a turbo code internal interleaver, comprising:
a window setting module, for dividing a sequence with a length of Kⱼ, which is input into a turbo code internal interleaver, into a plurality of windows each with a window length of Δⱼ, the window length Δⱼ satisfying 2f₂Δⱼ(mod Kⱼ)=0, and Kⱼ being divided exactly by Δⱼ, wherein f₂ is a parameter dependent on Kⱼ;
a first output index obtaining module, for obtaining output indices each of which corresponds to each input index in a first window; and
a second output index obtaining module, for calculating successively output indices each of which corresponds to each input index in a rest window according to the output indices each of which corresponds to each input index in the first window.

9. The device according to claim 8, wherein the first output index obtaining module is specifically used for reading from a memory or obtaining through calculation the output indices each of which corresponds to each input index in the first window.

10. The device according to claim 8, wherein
the plurality of windows refers to two or more windows; and/or
the sequence is a bit sequence or a soft bit sequence.

11. The method according to claim 2, wherein the plurality of windows refers to two or more windows.

12. The method according to claim 3, wherein the plurality of windows refers to two or more windows.

13. The method according to claim 2, wherein the step of obtaining output indices each of which corresponds to each input index in the first window, refers to:
reading from a memory or obtaining through calculation.

14. The method according to claim 3, wherein the step of obtaining output indices each of which corresponds to each input index in the first window, refers to:
reading from a memory or obtaining through calculation.

15. The method according to claim 13, wherein the step of obtaining output indices each of which corresponds to each input index in the first window through calculation is calculating with a following formula:
Π(i)=(f₁·i+f₂·i₂)mod Kⱼ
where i is an input index and set to 0, 1, 2, . . . , Kⱼ−1.

16. The method according to claim 14, wherein the step of obtaining output indices each of which corresponds to each input index in the first window through calculation is calculating with a following formula:
Π(i)=(f₁·i+f₂·i₂)mod Kⱼ
where i is an input index and set to 0, 1, 2, . . . , Kⱼ−1.

17. The method according to claim 2, wherein the sequence is a bit sequence or a soft bit sequence.

18. The method according to claim 3, wherein the sequence is a bit sequence or a soft bit sequence.

19. The device according to claim 9, wherein the plurality of windows refers to two or more windows; and/or the sequence is a bit sequence or a soft bit sequence.
